(19) United States
(12) Patent Application Publication
(10) Pub. No.: US 2008/0153334 A1
(43) Pub. Date: Jun. 26, 2008

(54) Safety interlocking electrical supply apparatus

(76) Inventor: Rupa Russell Vickers, Asheville, NC (US)

Correspondence Address: DAVID M. CARTER;CARTER & SCHNEDLER, P.A., P.O. BOX 2985, ASHEVILLE, NC, 28802, US

(21) Appl. No.: 12/005,859

(22) Filed: Dec. 12, 2007

Related U.S. Application Data
(60) Provisional application No. 60/876,807, filed on Dec. 22, 2006.
(60) Provisional application No. 60/876,802, filed on Dec. 21, 2006.

(51) Int. Cl. H01R 13/62

(52) U.S. Cl. 439/296

(57) ABSTRACT

A safety interlocking electrical supply apparatus including a base component housing at least two base electrical contacts which are wired to a source of electrical energy. The base component has a least two apertures. An intermediary component is provided having at least two intermediary electrical contacts extending therefrom. The apertures in the base component are adapted to removably receive the intermediary electrical contacts. The intermediary electrical contacts are adapted to make contact with the base electrical contacts. The intermediary component includes an end use mechanism. The intermediary component may be readily and safely connected to and removed from the base component without the need to make wire connections or disconnections.

### RELATIONSHIP TO PRIOR APPLICATION

This is a U.S. non-provisional application relating to and claiming the benefit of U.S. Provisional Patent Application Ser. No. 60/876,802, filed Dec. 21, 2006.

### FIELD OF THE INVENTION

This invention relates to electrical appliances. In particular, this invention relates to a two-component electrical supply apparatus and distribution system for human use whenever installation of electrical supply is needed and whenever access to electrical supply is needed.

This invention relates to a safety interlock power supply apparatus and more particularly to a mechanical interlock connector mechanism for supplying power to an electrically powered device from a structure's permanently installed wiring.

This invention relates to an interlocking electrical supply apparatus that allows for the harnessing of multiple levels of voltage power to be accessed via one intermediary component, without having to replace the intermediary component to access the different levels of power desired.

### BACKGROUND OF THE INVENTION

Various attempts have been made to overcome the problem of providing access to electrical current for the supply of power to electrical appliances while avoiding unnecessary hazards, such as electrical shock, burns, improper operating modes, and high labor costs.

There exist options to provide electrical supply in a physical structure, such as the use of a metal box with specific slots for bringing a wire into the box to make a connection to an outlet used as a connector for an appliance or the like.

There also exist electrical components that allow the user to adjust the placement of electrical supply for lighting specific appliances, as in the common track lighting systems.

While the above electrical supply systems have worked, their one major flaw is the extensive installation and labor intensive electrical renovation required to change the electrical supply outlet's composition to allow the user the freedom to switch end use of a particular power supply outlet. An example is the switching from a standard 110 volt lamp to a ceiling fan unit or to a smoke detecting unit.

Accordingly, there is a need for the end user to be able to newly install or to retrofit the electrical supply in a structure based on current needs for a particular electrical supply at a specific point of electric distribution.

Accordingly, it is an object of the invention to provide a multi-component electrical supply system.

### OBJECTS OF THE INVENTION

Another object of the invention is to make it easy for the user to be able to achieve freedom from expensive installation charges without violating national electrical installation ordinances.

Another object of the invention is to provide an interlocking fastening system so as to conduct electricity via connected conducting contact surfaces.

Yet another object of the invention is to provide a swiveling motion so as to interconnect the conducting contact surfaces creating a locking mechanism by such action.

A further object of the invention is to provide a handle on the public facing side of an intermediary component so as to allow ease of use of the intermediary component when attaching or un-attaching the components together.

Yet another object of the invention is to provide the opportunity for the end user to install and or uninstall an intermediary component so as to achieve the necessary electrical supply for a particular location in the surface of the structure.

Another object is to allow the conversion of the electrical supply into a variety of different configurations without the need for an electrician. An example of this object is the housing of a 440 volt electrical supply along with a 220 volt electrical supply to be housed in the same separate base and intermediary components and via the pivoting of a control on the intermediary component be able to switch access between the voltage options.

Another object of the invention is to allow the full force of the available source of electrical supply to enter the base component and be selectively harnessed within the intermediary component by the interlocking of the metal contact surfaces in a multitude of configurations for the purpose of accessing multiple power configurations without the need to remove or replace the intermediary component.

### BRIEF SUMMARY OF THE INVENTION

What is needed, therefore, is an inexpensive, easy to use and safe electrical supply apparatus consisting of two separate components which make up the whole of an interlocking electrical supply apparatus which is suitable for use in residential and commercial applications.

### BRIEF DESCRIPTION OF THE DRAWINGS

FIG. 1 is a side isometric view, partially cutaway, of safety interlocking electrical supply apparatus in a supinated position showing portions of the safety interlocking electrical supply apparatus including the intermediary component and the base component.

FIG. 2 is a bottom isometric view of the intermediary component showing conductor appendages.

FIG. 3 is a partially cutaway side isometric view of intermediary component showing some of its internal mechanisms and shown with two standard 110 volt electrical outlet configuration.

FIG. 4 is a partially cutaway side isometric view of the intermediary component shown with two standard 110 volt electrical outlet configuration.

FIG. 5 is an isometric side view of the intermediary component showing its external parts.

FIG. 6 is an isometric side view of the intermediary component shown in a smoke detector configuration.

FIG. 7 is an isometric exploded view of the entire two part electrical supply apparatus in one of its configurations in which the intermediary component includes a ceiling fan.

FIG. 8 is a bottom isometric view of the base component shown with a four (4) wire configuration.

FIG. 9 is a partially cutaway side view of the base component shown with three (3) contact entrance points configuration.

FIG. 10 is an isometric side view of the external top and side of the base component showing the male glides and the finger grasp/connector.

FIG. 11 is a side isometric partially cutaway view of the base component shown with the multi-electrical supply configuration, as a dual electrical supply apparatus and a portion of the intermediary component.

FIG. 12 is a top partially cutaway view of the base component showing multiple metal contact points for the multi-power supply configuration within the base component.

FIG. 13 is an isometric view of the structural housing box unit.

FIG. 14 is a top view of the rim cover plate for the intermediary component.

FIG. 15 is a partial isometric view of the rim cover plate.

FIG. 16 is a side isometric view of the intermediary component configured to supply two (2) electrical supply options without necessitating the removal and replacement of the intermediary component.

### DETAILED DESCRIPTION OF THE PREFERRED EMBODIMENTS

An interlocking electrical supply apparatus that is primarily made up of two components, namely an intermediary component and a base component, which are housed in a separate safety box housing. The electrical connection is made when the intermediary component is inserted into the base component with a pivoting action interlock and as a whole create an electrical supply system which can be installed and uninstalled by the consumer with a low risk to personal safety.

The base component of the system, along with the electrical box, is installed by an electrical professional, permanently into the surface wall of the physical structure. The intermediary component is a replaceable unit. The intermediary component is designed to be installed, removed and reinstalled as is needed by the user. Furthermore, the intermediary component is also designed to allow for a multitude of electrical output options without necessitating the removal and replacement of the intermediary component. The intermediary component can also be removed and replaced by any one of a number of different intermediary units, which configure the electrical supply into different configurations for the end user's need. This electrical supply apparatus will supply an uninterrupted, grounded, electrical current to any product assumed to utilize electricity via the interlocking connection between the permanently installed base component and the semi-permanent intermediary component which can be physically unattached from the permanently installed base component and replaced with any number of configurations suiting a variety of electrical supply standards. This electrical supply apparatus will conduct energy through two separate, independent components the sum of whose parts will deliver the electrical supply to the end use (e.g., a ceiling fan or two 110 volt power outlets). The semi-permanently installed intermediary component will preferably include the end use mechanism, such as a smoke detector installed into the intermediary component. This will allow the user the ease of changing electrical supply options for a particular base location based on the need at the moment for that base location, without the need for a certified professional to install or uninstall the intermediary component, and with no risk to the user.

Examples of another end use mechanism for the intermediary component would be a traditional 110-volt, three-prong, grounded electrical outlet, which is used to plug in standard 110-volt electrical products (e.g., a lighting fixture). Another example would be the standardized ceiling fan that would be built into the intermediary component. The electrical supply apparatus will provide a base component that will be installed at the time of construction or during retrofit of the electrical supply system which will be housed in the electrical housing box.

In addition, the electrical apparatus having two interlocking components housed in one modified electrical support housing box can be utilized, within the intermediary component, to harness power in different configurations. This can be done without needing to replace the intermediary component. Access to a power source (e.g., between a 440 or 220 volts supply) can be obtained by simply adjusting and thence reengaging the electrical contact points within the intermediary component within the permanently installed base component. This adjustment and reengagement can be achieved in any number of ways including rotating the intermediary component in an opposite direction while staying engaged in the base component.

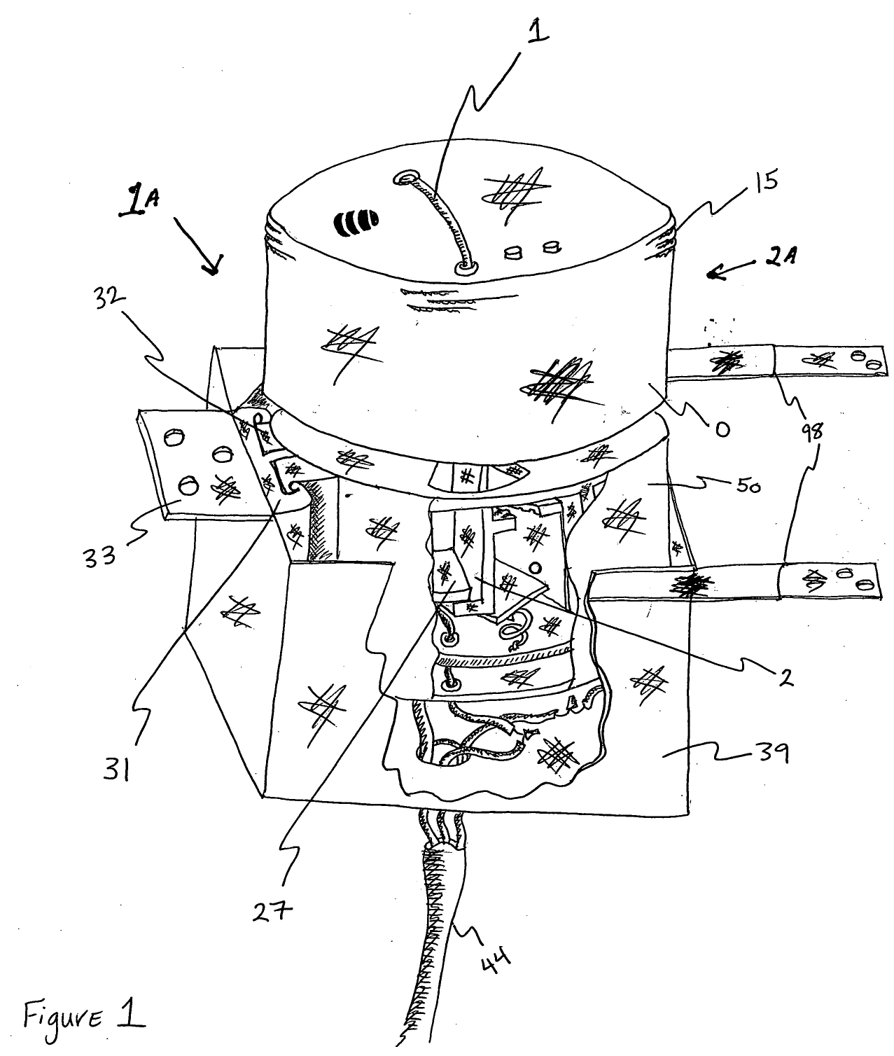

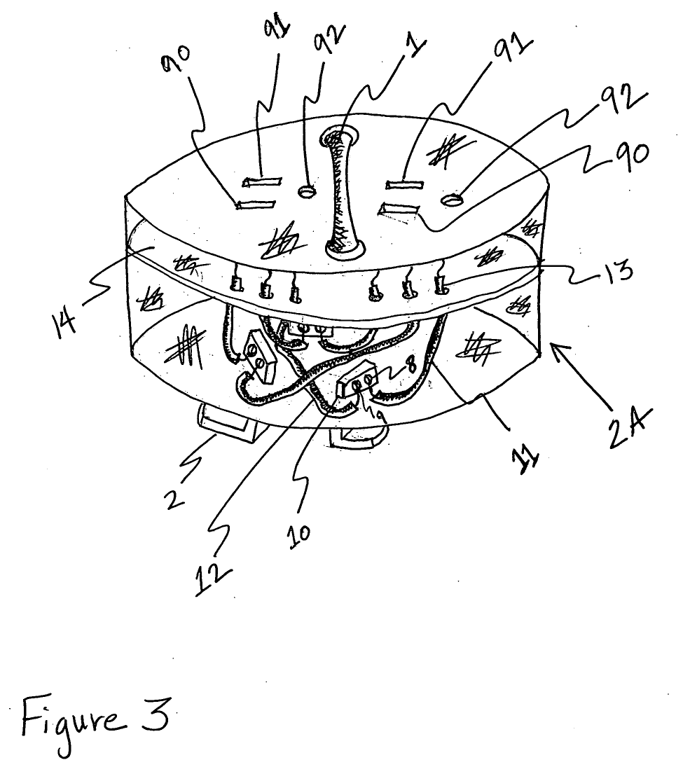

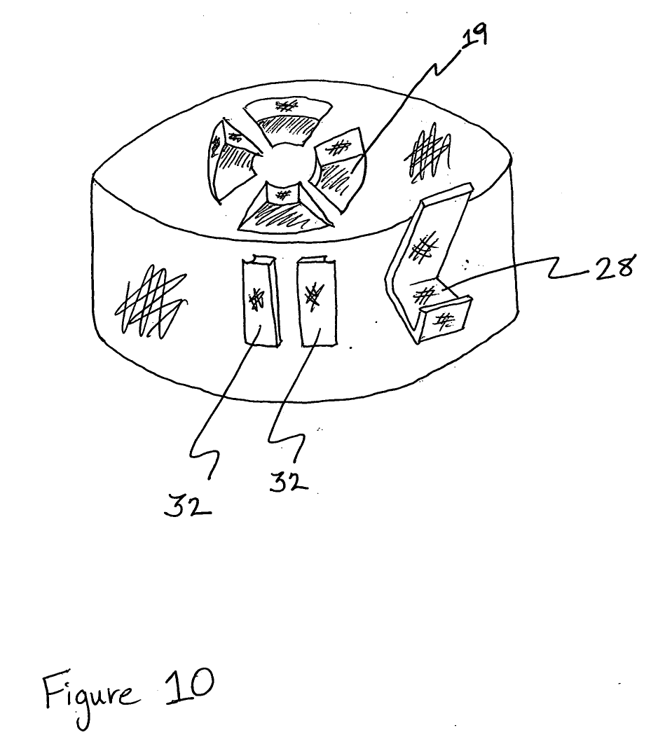

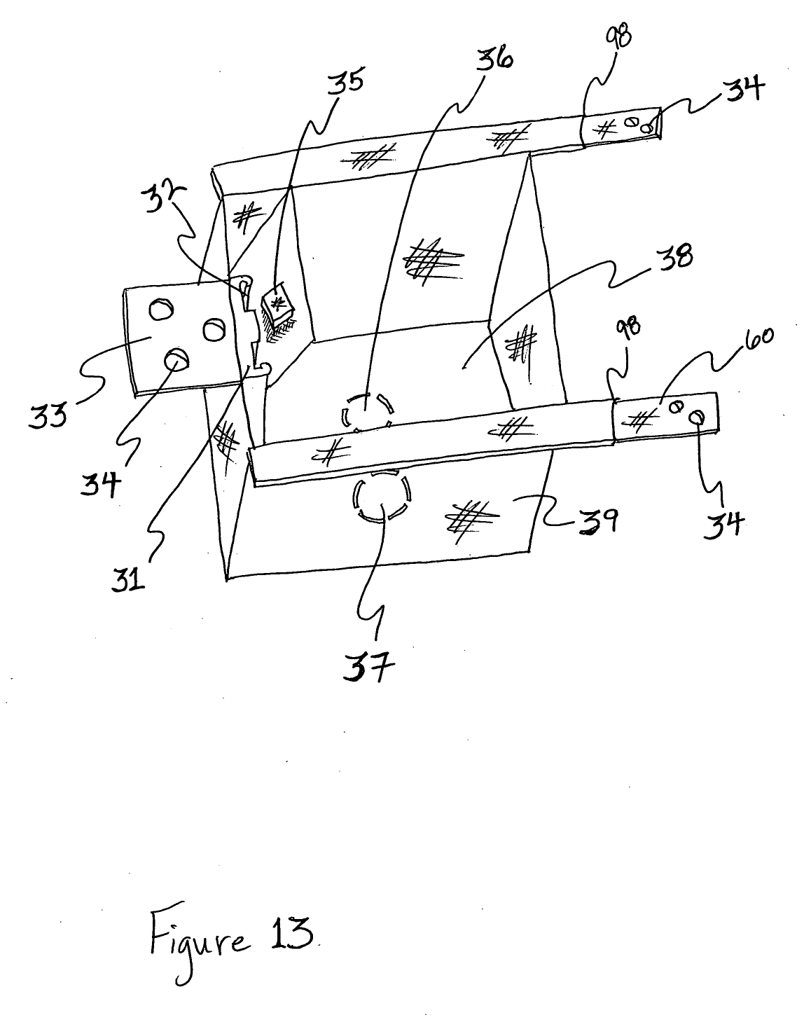

FIG. 1 shows the safety interlocking electrical supply apparatus (hereafter referred to as “Apparatus 1A”) in an inverted position. Apparatus 1A comprises a structural box 39 having a cavity into which a base component 50 may be slidably removed or inserted. Base component is a housing which receives electrical parts described below. Box 39 comprises two sliding female guides 31 to allow the male appendages 32 on the intermediary component 2A to slidably attach to the internal wall of the structural box cavity 39. The structural box cavity 39 is sized to closely mate with base component 50, thereby properly aligning and positioning base component 50 so the base component can be properly clamped into position by the interaction of clamp 28 as seen in FIG. 10 and clamp receiver 35 in FIG. 13. Apparatus 1A also comprises an interlocking intermediary component 2A appendages 2 which are inserted into openings in base component 50 by way of physical pressure. Once inserted, the intermediary component 2A is pivoted or swiveled with the use of handle 1 which with the use of pressure creates a locked or snapped position of conductor appendage 2 and conductor platform 27 and therefore allows the conduction of electrical energy via the internal mechanism pathways as seen in FIG. 3.

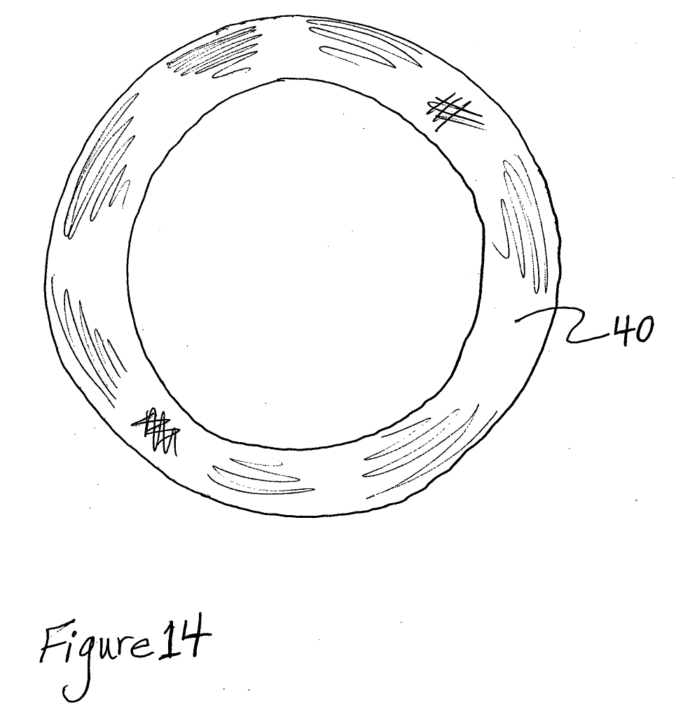

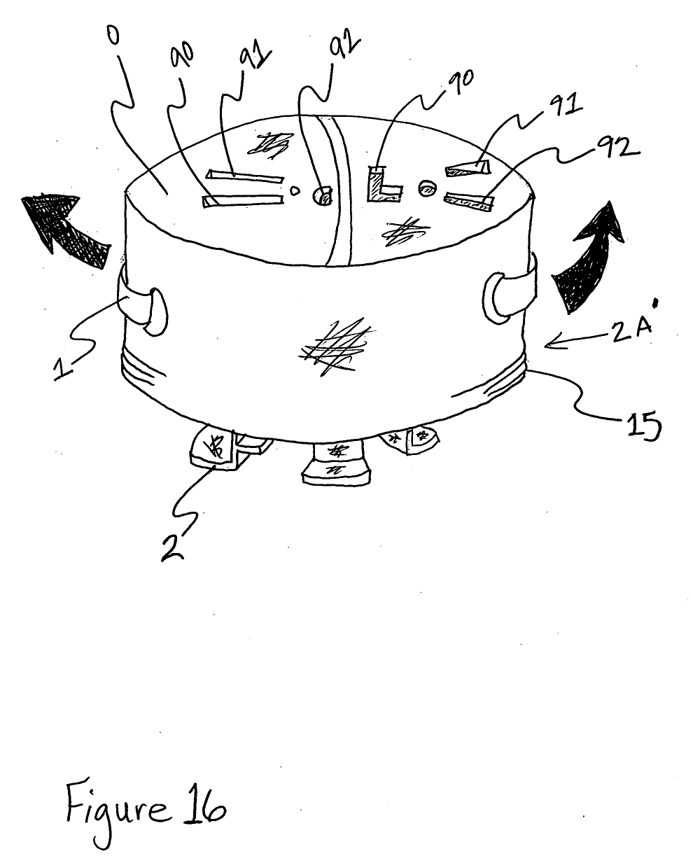

When fully inserted into base component 50, intermediary component 2A is affixed with a trim cover plate 40 as seen in FIG. 14, which screws around the edge of the intermediary component 2A′ at pathway 15 as seen in FIG. 16. The present invention is directed to a safety interlock power supply system that automatically eliminates component voltage upon removal of the intermediary component 2A from base component 50, thereby permitting safe installation and removal of the intermediary component 2A from the base component 50.

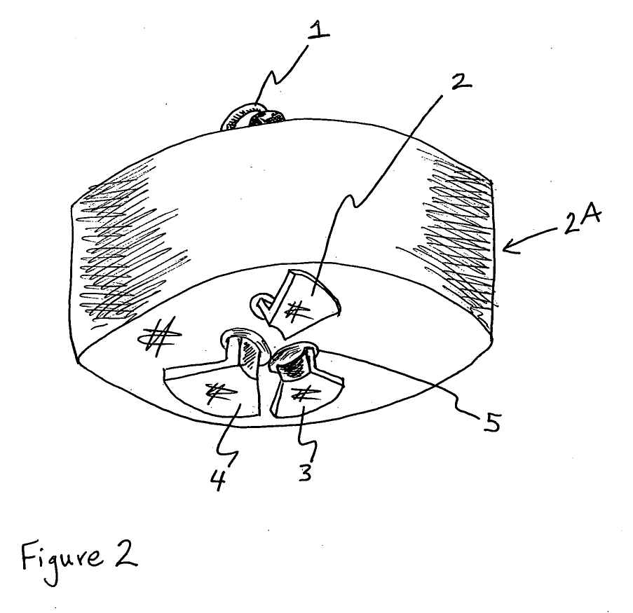

FIG. 2 shows the intermediary component's 2A bottom, or conductor appendages 2, 3, 4. The number of appendages could vary within the realm of this invention, determined by the supply and configurations needed for the intermediary component's 2A end point usage. Intermediary component 2A handle 1 is illustrated and would be utilized to assist in the interlocking of the two components and thence the conductor appendages 2, 3, 4 together.

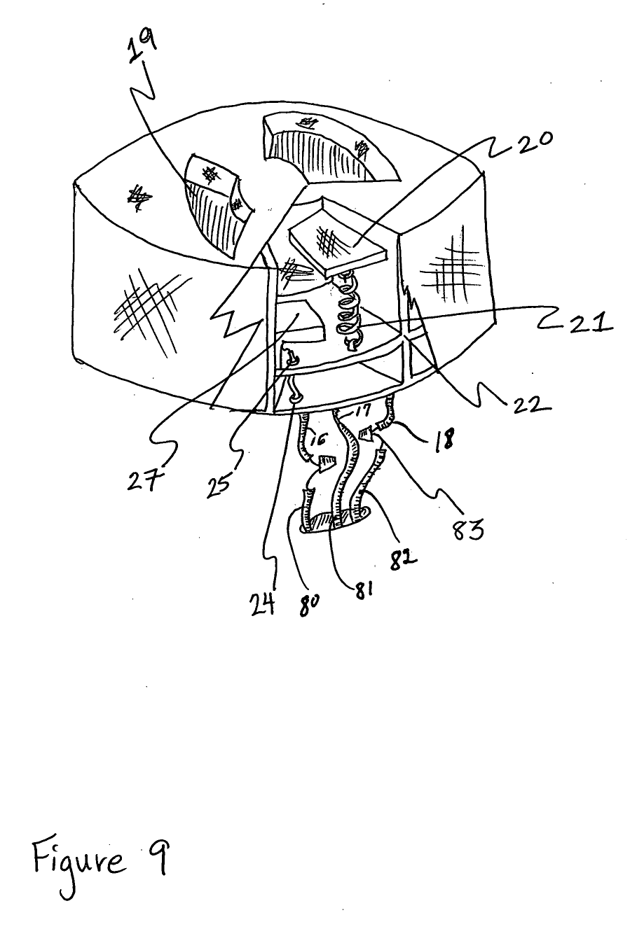

The pathway of electrical current will now be described as seen in FIGS. 3, 4, 6, 8, 9 and 11. An electrical current pathway is established by the connection of the mother supply wires 80, 81, and 82 to 16, 17 and 18 as seen in FIG. 9. What is now described is the electrical pathway for any electrical current brought through into the base component 50.

This pathway can be replicated any number of times to meet the electrical needs, but is shown in FIGS. 1, 2, 3, 4, 6, and 9 as an example with only three conductors and pathways. Alternatively, there can be conduction of electricity with unlimited potential for number of conductors. Once the mother wire is connected to the supply wires 16, 17 and or 18 of base component 50, the electrical current is carried up through into the internal mechanism of the base component 50 where it supplies electrical current to the conductors housed within 27 or 81. The wire is affixed to a metal pin or screw 80 which is directly affixed to the metal conducting platform 27, 81 that when in contact with the pivoting conductor appendage 2 continues the electrical current up via the conducting appendage into the intermediary component 1A which then carries the electrical current to metal pins or screw 8 and or 9 to which is connected either an individual wire or a number of wires up through holes 13 located in the distribution platform 14 (FIG. 3). The distribution platform's 14 purpose is to isolate the individual wires 11, 12 which in and of themselves continue the pathway of electrical current so that they can be affixed to the appropriate undesignated conductor pins or screw which will attach to any number of configurations of the end product mechanism which will end the electrical pathway of the invention and allow the end user to utilize the intermediary component 2A as intended.

FIG. 3 is shown with the intermediary component 2A configured to house two 110 volt electrical outlets. This intermediary component 2A could be configured to house any number of electrical components. An example would be the intermediary component 2A outfitted with a smoke detector fixture which would receive its electrical power supply as apart of the entirety of the Apparatus 1A.

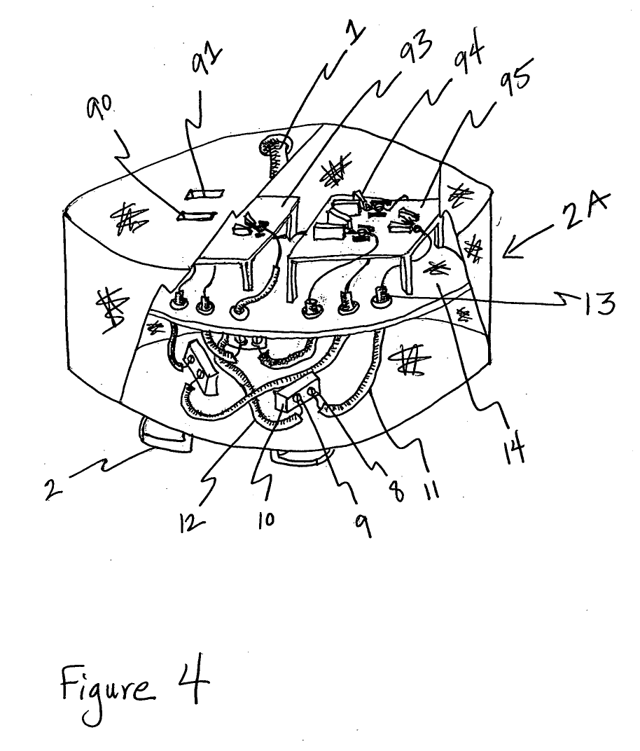

FIG. 4 is a cutaway view of the internal mechanism of the intermediary component 2A configured to house two 110 volt electrical outlets. The metal conductor appendages 2 provide a pathway of electrical power supply which are attached securely via metal wire 11, 12 to the head of the metal conductor appendage 10 via screws or penetrating pins 8, 9. The pathway is thus continued via the internal wires 11, 12 up through the distribution platform via holes 13 which are intended to keep the wires separated. The wires are then connected to the individual ground, neutral and hot plates within which are inserted the plug from the 110 volt appliance. The ground, neutral and hot plates 90, 91, 92 can be situated on a raised platform 93 above the distribution platform 14.

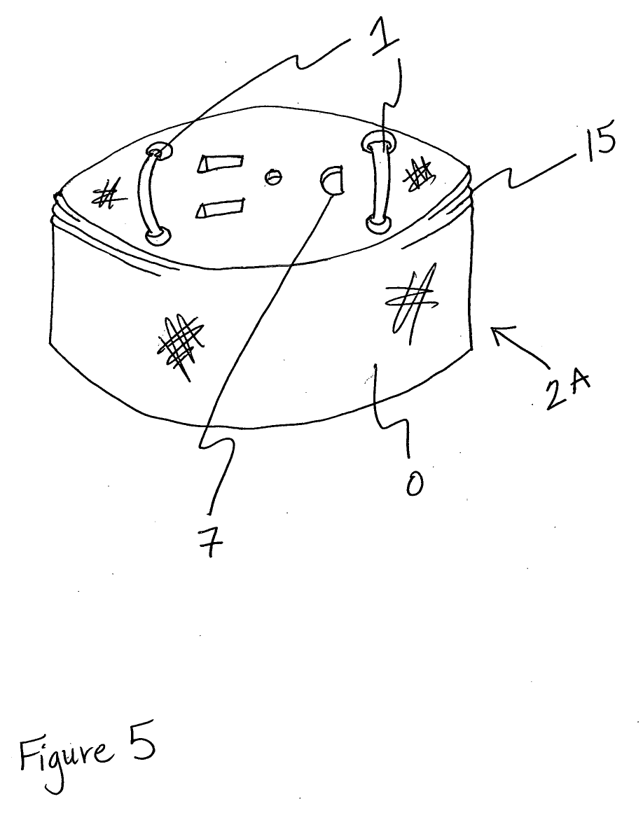

FIG. 5 is a view of the intermediary component 2A in one of its potential configurations for higher voltage power supply, such as 220 or 440. Two handles 1 are potentially configured to assist in the attachment of the intermediary component 2A to assist in the ease of connection of the intermediary component 2A to the base component 50. The view shows the ridged screw pathway 15 around which the rim cover plate 40 will be affixed via a turning motion. The insertion plug holes 7 show the location at which the 220 volt appliances plug will be inserted. This is just one potential configuration of the intermediary component 2A. The intermediary component has multiple end use configurations. In one possible configuration, by turning the intermediary component within the base component, different levels of voltage are accessed.

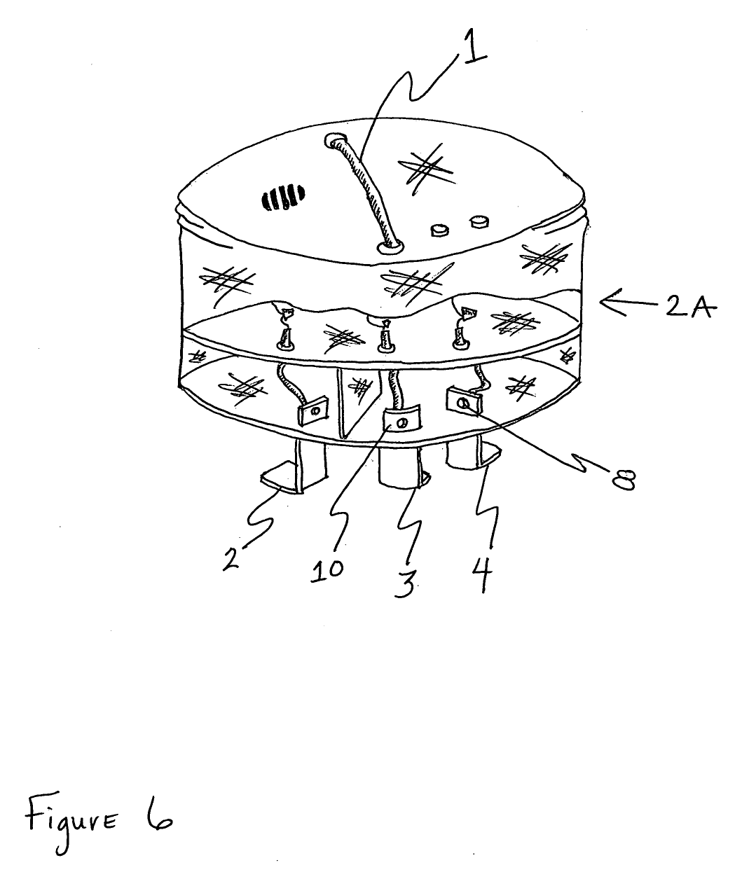

FIG. 6 is an isometric cutaway view of the intermediary component 2A as configured in one of its potential configurations as a smoke detector unit. The metal conductor appendages are shown 2, 3, 4 along with the screws or penetrating pins 8 which are affixed to the heads of the conductor plates 10.

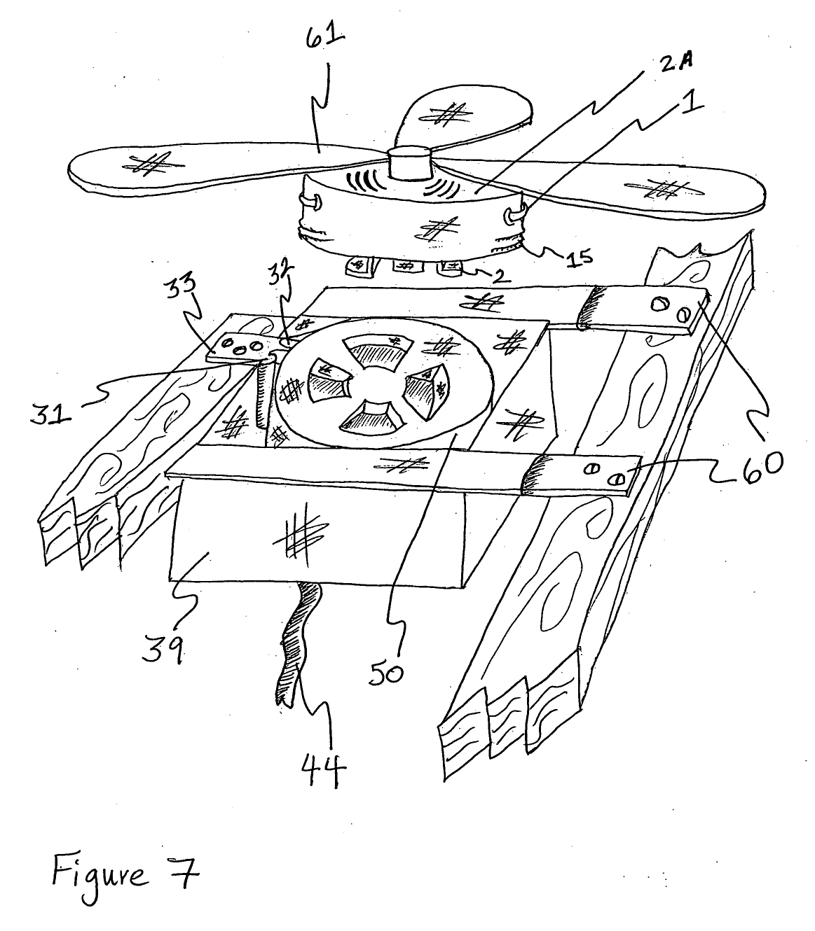

FIG. 7 is a view of the intermediary component 2A shown in its configuration as a ceiling fan. The handles are shown 1, as are the ceiling fan wings 61, and the ridged screw edge 15 around which the rim cover plate 40 from FIG. 14 would be affixed. The drawing also shows the base component 50 as housed in the box unit 39 which is attached to two supporting structures. The box unit 39 is affixed via the extendable support arms 60 via screws or nails which enter into the holes 60 penetrating the holes and entering into the supporting structure, thusly creating a firm support for the box unit 39.

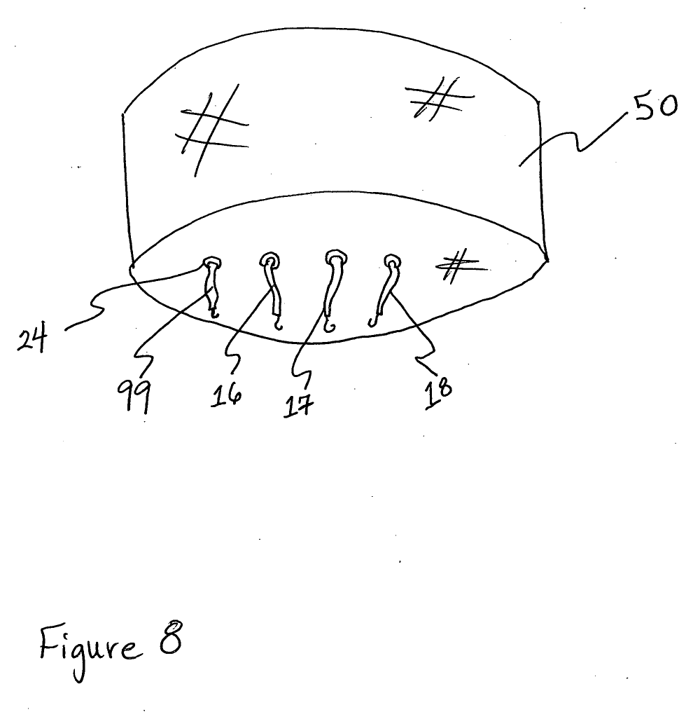

FIG. 8 is an isometric drawing showing the bottom of the base component 50. The main supply wires 16, 17, 18, 99 protrude from the bottom of the base component 50 through wire supply holes 24.

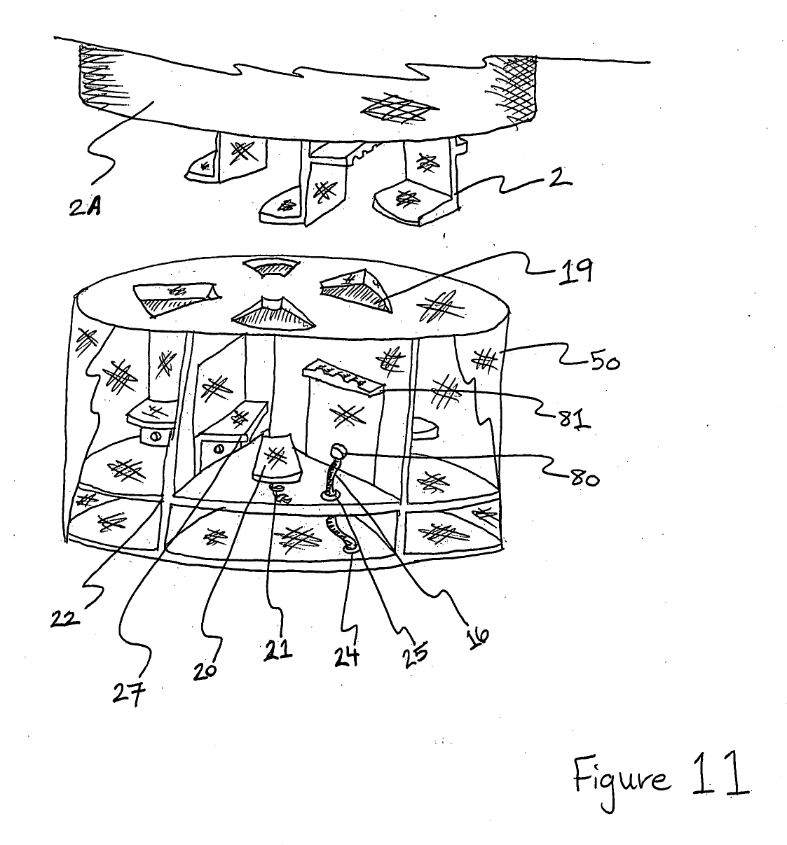

FIG. 9 is a cutaway view of the internal mechanism of the base component 50. Conductor appendages 2 are inserted into the base component 50 via appendage entry points 19. Such action causes the internal electrically insulated security covers 20 to depress inwards or downwards which causes the spring 21 to compress inwards. This action allows the conductor appendage 2 to enter into the base component 50 while also allowing the base component's internal electrical supply conductor platform 27, 81 (FIG. 11) or platforms to be covered from unintended entrance of non-intentional material or materials. When the conductor appendage 2 is inserted, the user then turns or pivots, with the assistance of the intermediary component 2A, handle 1. The intermediary component 2A thus causes the conductor appendage 2 and conductor platform 27 or 81 (FIG. 11) to engage and create the pathway for the electrical current.

FIG. 10 shows the external body of the base component 50. The appendage entry points 19 are shown in one potential configuration. The male glides 32 which are slid into the female supports 31 (FIG. 1) are shown. The finger press 28 which engages a further support feature 35 (FIG. 11) is shown.

FIG. 11 is a cutaway view of the base component 50 as configured for one of its potential purposes to harness multiple power options within the same base component 50. The drawing shows the appendage entry points 19 and the internal security cover 21 which is described in FIG. 9. The screws or penetrating pins 80 serve to affix the main supply wires 16 to the metal conducting plates 27, 81 which continues the pathway of electrical force ultimately making it available for contact with the conductor appendages 2 from FIG. 2. In its intended configuration, the metal conductor plates 27, 81 can be engaged by rotating the intermediary component 2A in different directions which will create two potential contact points between the metal appendages 2 and the conductor plates 27, 81 when rotated in opposite directions. The internal distribution platform 22 is shown, which separates the base component 50 into separate chambers. There are wire holes 24, 25 through which the supply wires 16 feed.

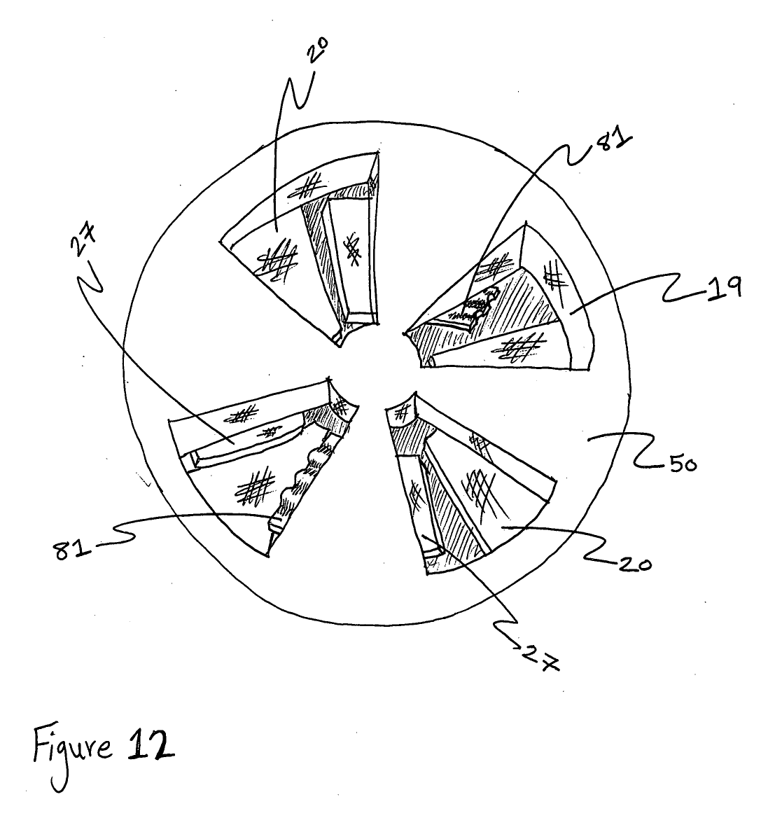

FIG. 12 is an overhead view of the base component 50 and the potential relation between the appendage entry points 19 and the conductor plates 27.

FIG. 13 is a drawing of the box unit 39 which is supported by its supporting arms 60 and supporting plate 33, each of which have holes 34 to use to affix the box unit 39 to the structure in question. Multiple potential punch-out mother wire supply openings 36, 37 are shown. The female support glide guide 31 is shown in the inside 38 of the unit 39 with the pathway 32 for the male glides to enter shown. The finger catch support 35 is shown on the surface of an internal wall, this engages with the finger catch 28 of FIG. 10. The supporting arms 60 are adjustable in length 98.

FIG. 14 is a top view of the rim cover plate 40.

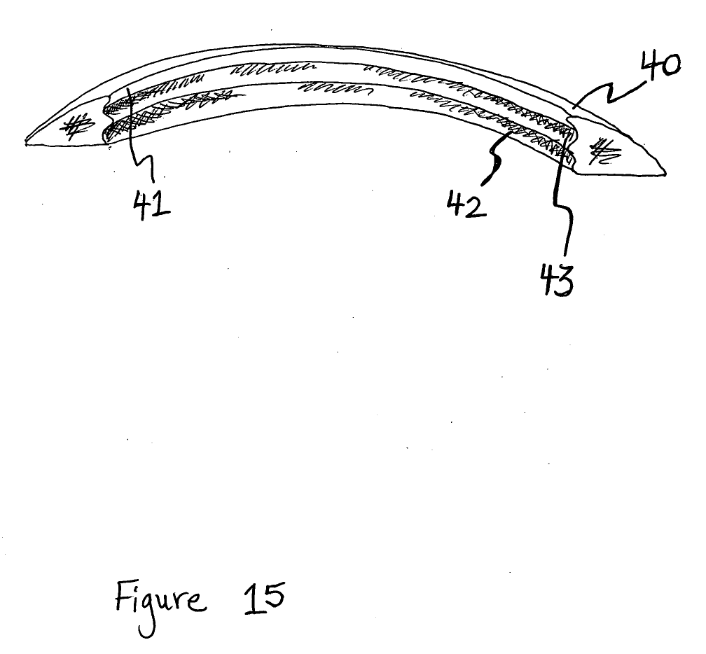

FIG. 15 a view of the rim cover plate 40. The rim cover plate 40 has ridges 41, 42, 43 on the inside of its cover plate which allow it to be threaded onto the intermediary component 2A ridges 15 (FIG. 1). The outside surface of the rim cover plate 40 is contoured to provide a smooth protective cover for the space surrounding the base component 50 and any surrounding surface.

FIG. 16 is an isometric view of the intermediary component 2A′ configured to provide dual power supply via the metal contact appendages 2. Two handles 1 are affixed to the side of the component to assist in the rotation of the intermediary component 2A. Insertion openings 90, 91, 92 are to provide entry way for the external appliances contact plugs in a variety of configurations.

### Drawing Elements Guide

2A Intermediary Component
1 Handle for Intermediary Component
2, 3, 4, 5 Metal Conductor Appendage
7 Opening for external plug
8, 9 Screw or penetrating pins Intermediary Component
10 Head of the metal appendage
11, 12 Supply Wire Intermediary Component
13 Supply Wire Holes Intermediary Component
14 Distribution Platform
15 Ridges for Rim Plate
16, 17, 18 Supply Wires Base Component
19 Appendage Entry Points
20 Internal Security Cover
21 Spring
22 Distribution Platform
24 Hole for Supply Wire Base Component
25 Supply Wire Base Component
27 Metal Conductor Plate
28 Finger Press
31 Female Glide Support
32 Male glides
33 Structural Support plate
34 Holes for external screws
35 Finger Press Catch
36, 37 Potential Punch Out Hole for Mother supply Wires
38 Internal area of Box Unit
39 Box Unit
40 Rim Cover Plate
41, 42, 43 Ridges for Rim Cover Plate
50 Base Component
61 Ceiling Fan wings
80 Screw or Penetrating Pins Base Component
81 Metal Conductor Plate
83 Wire connectors
90, 91, 92 Insertion openings for plug from external appliance
93 Support platform within Intermediary Component
94, 95 Metal Contact Points for external appliance plug
98 Slide portion of Adjustable Structural Support Arm 60

1. A safety interlocking electrical supply apparatus comprising:
a base component; said base component housing at least two base electrical contacts; said base electrical contacts being wired to a source of electrical energy; said base component having at least two apertures;
an intermediary component; at least two intermediary electrical contacts extending therefrom; said apertures in said base component adapted to removably receive said intermediary electrical contacts; said intermediary electrical contacts adapted to make contact with said base electrical contacts; and
said intermediary component including an end use mechanism; said intermediary component being readily and safely connectable to and removable from said base component without the need to make wiring connections or disconnections.

2. A safety interlocking electrical supply apparatus as set forth in claim 1 wherein said base component includes spring loaded electrically insulated covers aligned with said apertures in said base component.

3. A safety interlocking electrical supply apparatus as set forth in claim 1 wherein said intermediary component is adapted to be turned with respect to said base component so that said intermediary electrical contacts will make contact with said base electrical contacts.

4. A safety interlocking electrical supply apparatus as set forth in claim 3 further including means for interlocking said intermediary component to said base component after said intermediary electrical contacts make contact with said base electrical contacts.

5. A safety interlocking electrical supply apparatus as set forth in claim 1 wherein said intermediary electrical contacts are somewhat “L” shaped.

6. A safety interlocking electrical supply apparatus as set forth in claim 3 further including a handle attached to said intermediary component to enable one to more easily turn said intermediary component.

7. A safety interlocking electrical supply apparatus as set forth in claim 1 wherein said end use mechanism is taken from the group consisting of an electrical outlet, a ceiling fan, and a smoke detector.

8. A safety interlocking electrical supply apparatus as set forth in claim 1 further including an electrical supply box permanently mounted to a building structure; said base component mounted to said electrical supply box.

9. A safety interlocking electrical supply apparatus as set forth in claim 8 further including a first guide mechanism attached to said supply box; a second guide mechanism attached to said base component; said first guide mechanism adapted to intermate with said second guide mechanism.

10. A safety interlocking electrical supply apparatus as set forth in claim 8 further including an adjustable support mechanism attached to said electrical supply box.

11. A safety interlocking electrical supply apparatus as set forth in claim 1 wherein said base component and said intermediary component are configured so that said intermediary component may be switched to different voltage levels.

12. A safety interlocking electrical supply apparatus as set forth in claim 11 wherein said different voltage levels are obtained by turning said intermediary component when it is connected to said base component.
